(19) United States
(12) Patent Application Publication
(10) Pub. No.: US 2015/0068687 A1
(43) Pub. Date: Mar. 12, 2015

(54) REMOVABLE DOOR COVER

(71) Applicant: Clark Herold Ulysse, Minneapolis, MN (US)

(72) Inventor: Clark Herold Ulysse, Minneapolis, MN (US)

(21) Appl. No.: 14/021,370

(22) Filed: Sep. 9, 2013

(51) Int. Cl. E06B 3/30; E06B 3/70

(52) U.S. Cl. CPC E06B 3/30; E06B 3/7001
USPC 160/103; 160/405

(57) ABSTRACT

A cover is slideable over a door. The cover has: a first fabric cover layer for a door front; a second fabric cover layer for a door rear; a top layer joining the first fabric cover layer and the second fabric cover layer at a position to accommodate a door top; a side layer joining the first fabric cover layer and the second fabric cover layer at a position to accommodate free movement of a latch at a first side of a door; an open area between the first fabric cover layer and the second fabric cover layer at a position to accommodate door hinges at a second side of the door; and a closed or closeable area between the first fabric cover layer and the second fabric cover layer at a position to accommodate a bottom edge of the door.

### BACKGROUND OF THE INVENTION

1. Field of the Invention

The present invention relates to the field of protective covers and particularly fabric covers for doors.

2. Background of the Art

Doors are an important functional and decorative feature on buildings. Especially within apartment and hotel units they are subject to constant wear and abuse. Scratches and dents in doors in such temporary residences and dwellings are common. Lease or rental of such units becomes difficult where such obvious physical abuse, especially extreme abuse, is apparent. The cost of repairs on such doors can directly impact profits for the owners.

Additionally, in such temporary facilities, every door appears to be identical except for the numbers place thereon or adjacent to the room entrance. Mistaken or erroneous attempts to enter facilities rented or leased by another tend to be common.

A number of attempts have been made to address at least the damage aspects or appearance of damage aspects in doors. European Patent No. EP 1 891 294 B1 shows a decorative fabric that is hung over the top of the door and secured at the bottom of the door by mechanical fastening.

Published U.S. Patent Document 2006/0037714 (Imbra) shows a door cover constructed of plastic sheeting and/or fabric to protect the door from weather.

Published U.S. Patent Document 2011/0296666 (Silverman) show door covers with decorations on their exterior surfaces. Elastomeric materials that can be stretched to conform to the door are shown.

### SUMMARY OF THE INVENTION

A cover is slideable over a door. The cover has: a) a first fabric cover layer for a door front; a second fabric cover layer for a door rear; b) a top layer joining the first fabric cover layer and the second fabric cover layer at a position to accommodate a door top; c) a side layer joining the first fabric cover layer and the second fabric cover layer at a position to accommodate free movement of a latch at a first side of a door; d) an open area between the first fabric cover layer and the second fabric cover layer at a position to accommodate door hinges at a second side of the door; and e) a closed or closeable area between the first fabric cover layer and the second fabric cover layer at a position to accommodate a bottom edge of the door.

### BRIEF DESCRIPTION OF THE FIGURES

FIG. 1 shows a perspective view of a fitted door cover that can be slid over a door and then secured to stabilize the position of the door cover.

### DETAILED DESCRIPTION OF THE INVENTION

A cover is slideable over an installed door. The cover has at least a first fabric cover layer for a door front; a second fabric cover layer for a door rear; and a top layer joining the first fabric cover layer and the second fabric cover layer at a position to accommodate a door top. There is a side layer joining the first fabric cover layer and the second fabric cover layer at a position to accommodate free movement of a latch at a first side of a door. There is an open area between the first fabric cover layer and the second fabric cover layer at a position to accommodate door hinges at a second side of the door, Finally, a closed or closeable area is between the first fabric cover layer and the second fabric cover layer at a position to accommodate a bottom edge of the door.

The cover is made of at least fabric materials, and the fabric materials (all or some) in the cover are machine washable and/or dry-cleanable. The fabric may have the same or different designs on the opposed sides (an inside and outside) of the fabric so that it may be reversible. The fabric may be made from synthetic and/or natural fabric material and may be lined (e.g., for sound insulation, fire insulation, and the like) or unlined.

The first fabric layer and the second fabric layer may have openings therein to accommodate door handles on opposite major faces of the door. These opening are adjacent the side accommodating the latch. The first fabric layer and the second fabric layer may have multiple connectors that open and close over a closeable area between the first fabric layer and the second fabric layer. The connectors may be positioned along the closeable area at distances that will accommodate at least two hinges.

The first fabric layer and the second fabric layer may have multiple connectors that an open and close over a closeable area at a bottom of the door between the first fabric layer and the second fabric layer.

The cover may have a connector system that is configured to pass under the door and attach the first fabric layer and the second fabric layer. The connector system may lock with fabric connectors (e.g., Velcro™ fasteners), snaps, hooks and eyelets or any other mechanical fastening system. The connectors can assist in fitting or stabilizing the cover to conform to the door.

A method of covering a door can be practiced with steps that may include: positioning the above described cover adjacent to a door attached to a frame through the hinges; sliding the open area between the first fabric cover layer and the second fabric cover layer with an open area to accommodate hinges over the first side of the door; bringing the side layer joining the first fabric cover layer and the second fabric cover layer into contact with the first side of the door; and stabilizing the cover over the door by securing at least one open area together that is present. Stabilizing the cover over the door may be accomplished by securing together the open area between the first fabric cover layer and the second fabric cover layer at a position to accommodate door hinges at a second side of the door and/or by bringing the fabric between the first fabric layer and the second fabric cover layer into contact with the first side of the door; and stabilizing the cover over the door by securing the multiple connectors. This can be done by bringing the side layer joining the first fabric cover layer and the second fabric cover layer into contact with the first side of the door; and stabilizing the cover over the door by securing the multiple connectors. Stabilizing the cover over the door may also be performed by securing together the first fabric cover layer and the second fabric cover layer at a position at a bottom of the door.

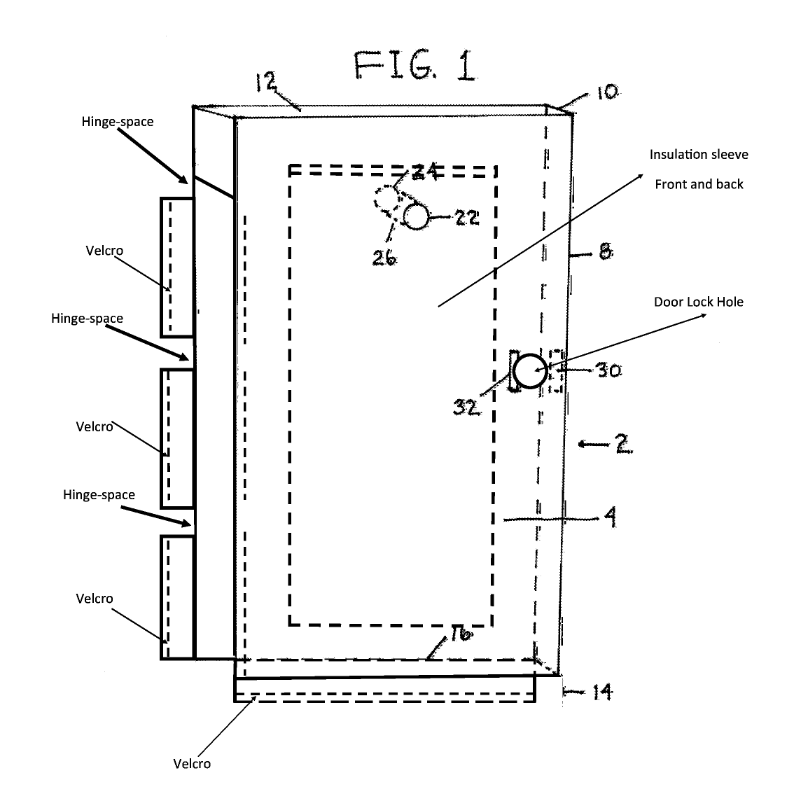

A consideration of FIG. 1 will assist in better appreciating the aspects of the present technology. FIG. 1 shows a perspective view of a fitted door cover 2 that can be slid over a door and then secured to stabilize the position of the door cover 2. The door cover 2 is shown with a first, front surface fabric material 4 and a second, back surface fabric material 6. The front fabric 4 and the back fabric 6 surfaces are secured by a top fabric area 12 and a latch-side fabric area 10. These securing fabrics assist in providing a stable unitary door cover 2 that can be slid over a door (not shown). The opposite side of the cover 2 (from the latch-side fabric area 10) defines a generally or completely open area 28 which can receive the edge of a door (not shown). By inserting a door into area 28, the door may be slid laterally into the door cover 2 until the latch-side of the door nestles against the latch-side fabric area 10. The opposite side of the cover 2 is the hinge-side of the cover 2. Fabric or structural material 8 on the latch-side fabric area 10 should be provided with a slot or opening 30 through which the latch may pass without interruption. The fabric or material 8 may be thinner than the fabric on the surfaces 4 and 6 to assure that confirmation and clearance between the latch-side of the door and the frame is not adversely affected.

Stabilizing or connecting elements 18 and 20 are shown on the back-side fabric 6 adjacent the opening 28. When the cover has been slid over the door, the connectors 18 and 20 are secured to the front fabric 4 to stabilize the door cover in a horizontal position with respect to the door (preventing sliding left or right) and with respect to horizontal movement of the fabrics adjacent the hinge-side of the door. Without such connectors, the fabric surfaces 4 and 6 could freely be freely and accidentally lifted away from the door.

Similarly, movement away from the bottom of the door (not shown) may be stabilized or reduced by providing a connector element 14 which can be adjusted to secure the front fabric surface 4 to the bottom 16 of the rear fabric surface 6.

As many temporary residence doors contain peep holes for resident security, an exterior hole 22 and interior hole in the front fabric surface 4 and the rear fabric surface 6, respectively can be provided to enable a through hole 26 compatible with the peep hole on a door. The through hole may be provided after placement of the cover 2 over the door, as the positioning of peep holes may not be as standard as door sizes.

The various fabrics and materials on the surfaces 4 and 6 and the side 10 and the top 12 may be of the same or different materials. They should be washable (as described elsewhere), may be insulated or not, reversible or not, and may contain active ingredients (anti-odorants and fire retardants, for example). To assist in preventing theft of the cover (which would be difficult in any event, because of the fitted nature over the latch side of the door and the top) the connecting elements 20 may extend from the front fabric surface 4 to the back fabric surface 6 and be more securely physically connected as with ties, grommets and posts, snaps and the like. Similarly, the fabric connector 14 (which might have extended from the back surface 6 to the front surface 4) may also have more secure locking means behind the door that mere fabric locks or attaching systems.

What is claimed:

1. A cover slideable over a door comprising:
a first fabric cover layer for a door front;
a second fabric cover layer for a door rear;
a top layer joining the first fabric cover layer and the second fabric cover layer at a position to accommodate a door top;
a side layer joining the first fabric cover layer and the second fabric cover layer at a position to accommodate free movement of a latch at a first side of a door;
an open area between the first fabric cover layer and the second fabric cover layer at a position to accommodate door hinges at a second side of the door; and
a closed or closeable area between the first fabric cover layer and the second fabric cover layer at a position to accommodate a bottom edge of the door.

2. The cover of claim 1 wherein all fabric materials in the cover are machine washable.

3. The cover of claim 1 wherein at least some fabric material in the cover is dry-cleanable.

4. The cover of claim 1 wherein the first fabric layer and the second fabric layer have openings therein to accommodate door handles adjacent the side accommodating the latch.

5. The cover of claim 1 wherein the first fabric layer and the second fabric layer have multiple connectors that an open and close over a closeable area between the first fabric layer and the second fabric layer.

6. The cover of claim 5 wherein the connectors are positioned along the closeable area at distances that will accommodate at least two hinges.

7. The cover of claim 4 wherein the first fabric layer and the second fabric layer have multiple connectors that an open and close over a closeable area at a bottom of the door between the first fabric layer and the second fabric layer.

8. The cover of claim 7 wherein the connectors are positioned along the closeable area at distances that will accommodate at least two hinges.

9. The cover of claim 5 wherein there is a connector system that is configured to pass under the door and attach the first fabric layer and the second fabric layer.

10. The cover of claim 8 wherein there is a connector system that is configured to pass under the door and attach the first fabric layer and the second fabric layer.

11. A method of covering a door comprising:
positioning the cover of claim 1 adjacent a door attached to a frame through the hinges;
sliding the open area between the first fabric cover layer and the second fabric cover layer with an open area to accommodate hinges over the first side of the door;
bring the side layer joining the first fabric cover layer and the second fabric cover layer into contact with the first side of the door; and
stabilizing the cover over the door by securing at least one open area together that is present.

12. A method of covering a door comprising:
positioning the cover of claim 4 adjacent a door attached to a frame through the hinges;
sliding the open area between the first fabric cover layer and the second fabric cover layer with an open area to accommodate hinges over the first side of the door;
bring the side layer joining the first fabric cover layer and the second fabric cover layer into contact with the first side of the door; and
stabilizing the cover over the door by securing together the open area between the first fabric cover layer and the second fabric cover layer at a position to accommodate door hinges at a second side of the door.

13. A method of covering a door comprising:
positioning the cover of claim 5 adjacent a door attached to a frame through the hinges;
sliding the open area between the first fabric cover layer and the second fabric cover layer with an open area to accommodate hinges over the first side of the door;
bring the side layer joining the first fabric cover layer and the second fabric cover layer into contact with the first side of the door; and
stabilizing the cover over the door by securing the multiple connectors.

14. A method of covering a door comprising:
positioning the cover of claim 6 adjacent a door attached to a frame through the hinges;
sliding the open area between the first fabric cover layer and the second fabric cover layer with an open area to accommodate hinges over the first side of the door;
bring the side layer joining the first fabric cover layer and the second fabric cover layer into contact with the first side of the door; and
stabilizing the cover over the door by securing the multiple connectors.

15. A method of covering a door comprising:
positioning the cover of claim 7 adjacent a door attached to a frame through the hinges;
sliding the open area between the first fabric cover layer and the second fabric cover layer with an open area to accommodate hinges over the first side of the door;
bring the side layer joining the first fabric cover layer and the second fabric cover layer into contact with the first side of the door; and
stabilizing the cover over the door by securing together the first fabric cover layer and the second fabric cover layer at a position at a bottom of the door.

16. A method of covering a door comprising:
positioning the cover of claim 8 adjacent a door attached to a frame through the hinges;
sliding the open area between the first fabric cover layer and the second fabric cover layer with an open area to accommodate hinges over the first side of the door;
bring the side layer joining the first fabric cover layer and the second fabric cover layer into contact with the first side of the door; and
stabilizing the cover over the door by securing together the first fabric cover layer and the second fabric cover layer at a position at a bottom of the door.
